(19) United States
(12) Patent Application Publication
(10) Pub. No.: US 2014/0346191 A1
(43) Pub. Date: Nov. 27, 2014

(54) DEVICE FOR STORING, SELECTING, AND DISTRIBUTING A PLURALITY OF PRODUCTS EACH OF WHICH IS PACKAGED IN A CONTAINER PROVIDED WITH AN EJECTION OPENING

(71) Applicant: FILLON TECHNOLOGIES, Faverolles (FR)

(72) Inventors: Aurelien Brule, Barjouville (FR); Antoine Chassaing, Clevilliers (FR); Anthony Valot, Saint Laurent La Gatine (FR)

(73) Assignee: FILLON TECHNOLOGIES, Faverolles (FR)

(21) Appl. No.: 14/357,609

(22) PCT Filed: Nov. 6, 2012
(86) PCT No.: PCT/FR2012/052561

§ 371 Date: May 12, 2014

(30) Foreign Application Priority Data
Nov. 28, 2011 (FR) 1160850

(51) Int. Cl. B67D 7/78; B67D 7/06

(52) U.S. Cl. CPC B67D 7/78; B67D 7/0216
USPC 222/144; 222/144.5

(57) ABSTRACT

A storage device for storing, selecting, and dispensing a plurality of products, each of which is packaged in a container provided with an expulsion orifice, the device including at least one products-carrier wheel that is centrally hollow and has a horizontal axis, and drive elements for driving the wheel in rotation. The device further includes a base on which the wheel is suitable, via the drive elements for driving the wheel in rotation, for standing merely by bearing against the base, the drive elements including at least two rotary circular members, at least one of the members being a driven member, these rotary circular members, incorporated into the base such that, when the wheel is bearing on the base, are tangential to the wheel, and extend on either side of a diametrical plane of the wheel, with their axes of rotation parallel to the axis of rotation of the wheel.

The present invention relates to a device for storing, selecting, and dispensing a plurality of products, each of which is packaged in a container provided with an expulsion orifice.

It relates more particularly to a device for storing, selecting, and dispensing a series of base tints for paint, in particular automotive paint, each tint being packaged in a flexible container of the pouch type provided with an expulsion orifice.

In the field of paints prepared on demand, in particular by automotive repair professionals, bodywork repair specialists prepare the quantities of paint necessary for bodywork repairs by mixing a certain number of base tints. Each mixture is determined on the basis of a formula defined by the paint manufacturer, that formula giving the weight of each base tint to be incorporated for a given quantity of mixture to be obtained.

Such preparations commonly involve mixing from five to ten base tints in order to obtain the particular shade required by the paint manufacturer.

In order to facilitate such mixing, a device includes at least one products-carrier wheel provided with a plurality of product-receiving locations disposed in at least one circumferential row, such a wheel being centrally hollow, and having a horizontal axis, and each product-receiving location being positionable by turning the products-carrier wheel into register with a collector receptacle.

Such a device further includes drive means for driving said products-carrier wheel in rotation.

Such a device is described, in particular, in Patents EP 2 145 677 and EP 2 135 668. Those devices offer a large number of advantages. However, their architecture can make them difficult to maintain.

An object of the present invention is thus to propose a device, of the above-mentioned type, that is of design making it possible to mount/dismount the various portions of the device in a short time in order to facilitate maintenance.

Another object of the present invention is to propose a device of the above-mentioned type that is of design making it easy to repair without requiring action from a specialist technician.

Another object of the present invention is to propose a device of the above-mentioned type that is of design making it possible to operate in degraded mode, i.e. with a wheel that turns at a slow speed continuously or intermittently without it being possible to dispense the products in quantified manner into the collector receptacle, it remaining possible to extract a container from the wheel so as to enable mixing to take place using external means, while the slow turning makes it possible to avoid any settling of the particles present in suspension in said products.

To this end, the invention provides a storage device for storing, selecting, and dispensing a plurality of products, in particular a series of base tints for automotive paint, each of which is packaged in a container provided with an expulsion orifice, said device including at least one products-carrier wheel that is centrally hollow and has a horizontal axis, and drive means for driving the products-carrier wheel in rotation, said products-carrier wheel being provided with a plurality of product-receiving locations disposed in at least one circumferential row, each product-receiving location being selectively positionable by turning the products-carrier wheel into register with a collector receptacle, said storage device being characterized in that the device further includes a base on which the products-carrier wheel is suitable, via the drive means for driving the products-carrier wheel in rotation, for standing merely by bearing against said base, said drive means for driving the products-carrier wheel in rotation comprising at least two rotary circular members, at least one of the rotary circular members being a driven member, these rotary circular members, incorporated into the base being members that, when the products-carrier wheel is in the configuration in which it is bearing on the base, are tangential to the products-carrier wheel and in particular to the outer rim of the products-carrier wheel, and extend on either side of a diametrical plane of the products-carrier wheel, with their axes of rotation parallel to the axis of rotation of the products-carrier wheel.

The fact that the wheel is merely stood on the base makes it easy for said wheel to be mounted/dismounted in a short time. The base incorporates the drive means for driving the wheel in rotation that are interposed between the wheel and the base in the state in which the wheel is standing on said base. The drive means for driving the wheel in rotation thus serve as support members for supporting the wheel on the base and as drive members for driving the wheel in rotation relative to the base.

In the event of failure or malfunctioning of said drive means for driving the wheel in rotation, the fact that the drive means for driving the wheel in rotation are incorporated in the base makes it possible to need only to change the base before repositioning the wheel on the base merely by allowing it to bear thereon. The wheel can thus be exempt from any pneumatic or electric control member. As a result, the risk of the wheel failing is almost zero.

The fact that the drive means for driving the wheel in rotation are housed in the base and are made independent from the metering or dispensing means that are described below, makes it possible to continue to drive the wheel in rotation even when the metering or dispensing means are defective or need to undergo maintenance.

Preferably, the circular members are members of the wheel, roller, or cog type, each provided on its outer circumference with at least one set of teeth or notches suitable for coming to mesh with a portion of an outer circumferential set of teeth or notches of the products-carrier wheel, in the configuration in which the products-carrier wheel is bearing on the base.

These circular members thus serve more than one purpose because they carry the wheel having a horizontal axis and they also drive it in rotation.

Preferably, the base is in the form of a box that is open over its top face, said rotary circular members and their rotary-drive driving means being disposed inside the box.

As a result, it is easy to access the drive means for driving the wheel in rotation because it suffices to remove the wheel merely standing on the base in order to have access to said drive means for driving the wheel in rotation that are masked by the wheel in the state in which it is standing on the base.

Preferably, the device further includes support means for supporting said collector receptacle, which means comprise at least one upside-down U-shaped structure of the bridge type, each of the flanges of the U-shape extending on the same side as a respective face of the products-carrier wheel and bearing on the base while the web of the U-shape, which web is suitable for forming a support frame for the collector receptacle, passes through said products-carrier wheel.

This U-shaped support structure that flanks the faces of the wheel at least in part does not adversely affect the ease with which the wheel can be dismounted from the base and from the drive means for driving the wheel in rotation.

Preferably, the web of the U-shape is provided with a guide path along which a carriage is mounted to slide in a direction parallel to the axis of rotation of the products-carrier wheel, said carriage including weigh means for weighing the collector receptacle, a closable pressurized air outlet and open/close control means for opening and closing the expulsion orifice of the product container in the state in which the product-receiving location of said container is positioned in register with the collector receptacle, said weigh means, the pressurized air outlet and the control means being mounted to move upwards and downwards on said carriage.

Preferably, at least a portion of the web of the U-shape incorporates a removable housing having one of its faces provided with said guide path along which the carriage is mounted to slide, said housing being an interface housing forming an interface between the carriage and the base.

The housing and the carriage form an assembly that incorporates a large number of sensitive elements of the device. Since they are mounted removably on the remainder of the support structure, they can be replaced rapidly in order to avoid the device being out of action for long periods of downtime.

In addition, each product-receiving location is associated with locking means suitable for locking the product container at said product-receiving location, said locking means being unlockable via unlocking means carried by said carriage.

It is also possible to unlock the containers automatically when the unlocking means are, for example of the actuator type.

Also preferably, each product-receiving location of the products-carrier wheel is provided with at least two series of through orifices, each of which is disposed in at least one circumferential row, each of the orifices of the first series of through orifices corresponding to a bore through which the expulsion orifice of a product container, which orifice is incorporated into a valve, is suitable for projecting from the products-carrier wheel, each of the orifices of the second series of through orifices corresponding to an air feed inlet.

As a function of the angular position of said products-carrier wheel, the orifices of the first series of orifices are selectively positionable to be facing the open/close control means for opening and closing the expulsion orifice of the product container of the carriage and the orifices of the second series of orifices are selectively positionable to be facing the pressurized air outlet of the carriage.

The device further includes a casing formed by cladding of the side wall type, provided with at least one access door.

The casing may make it possible to isolate from the outside the hollow inside of the wheel, inside which the metering operation takes place, and thereby to avoid any disturbance resulting from dust or draughts during said metering.

This casing, that safeguards user safety and limits access to the core of the device, also facilitates heating the inside of the wheel if necessary.

The invention can be well understood on reading the following description of embodiments given with reference to the accompanying drawings, in which:

FIG. 1 is a perspective view of the products-carrier wheel equipped with containers each provided with an expulsion orifice;

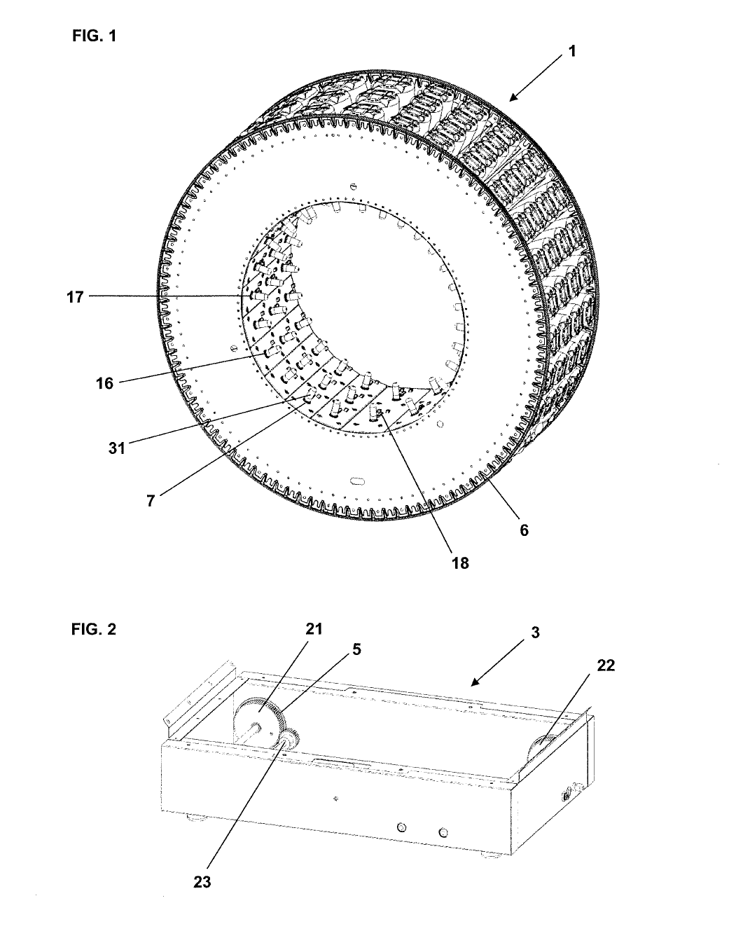

FIG. 2 is a perspective view of the base on its own;

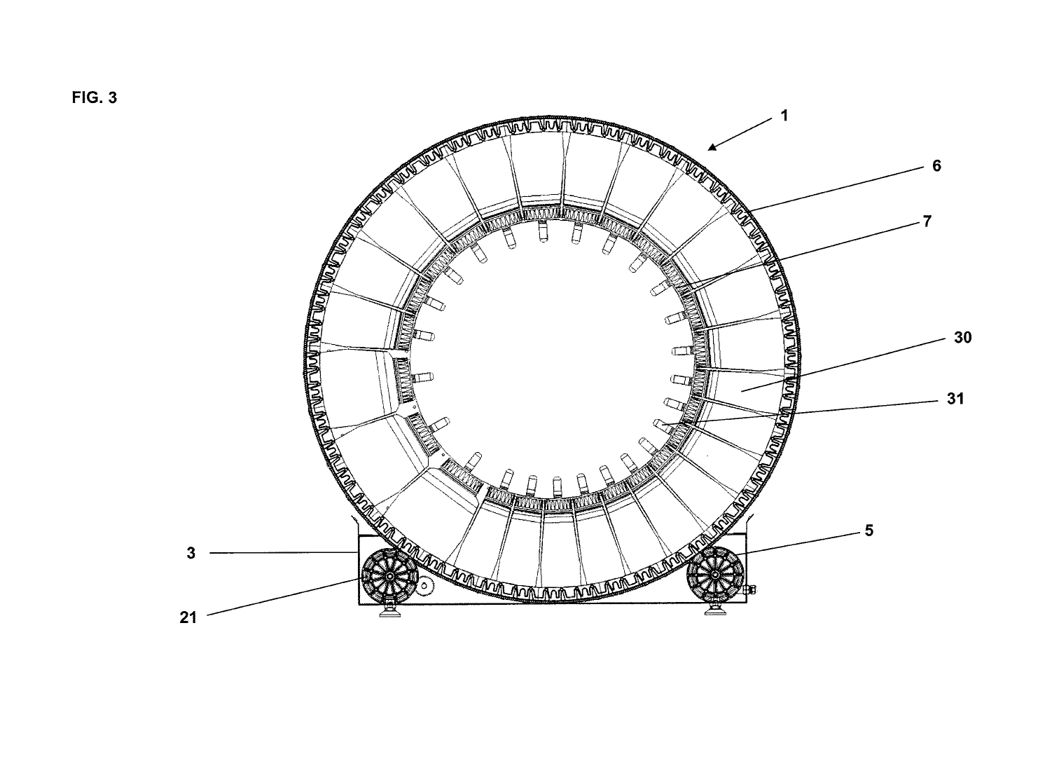

FIG. 3 is a section view of the wheel in the state in which it is standing on the base;

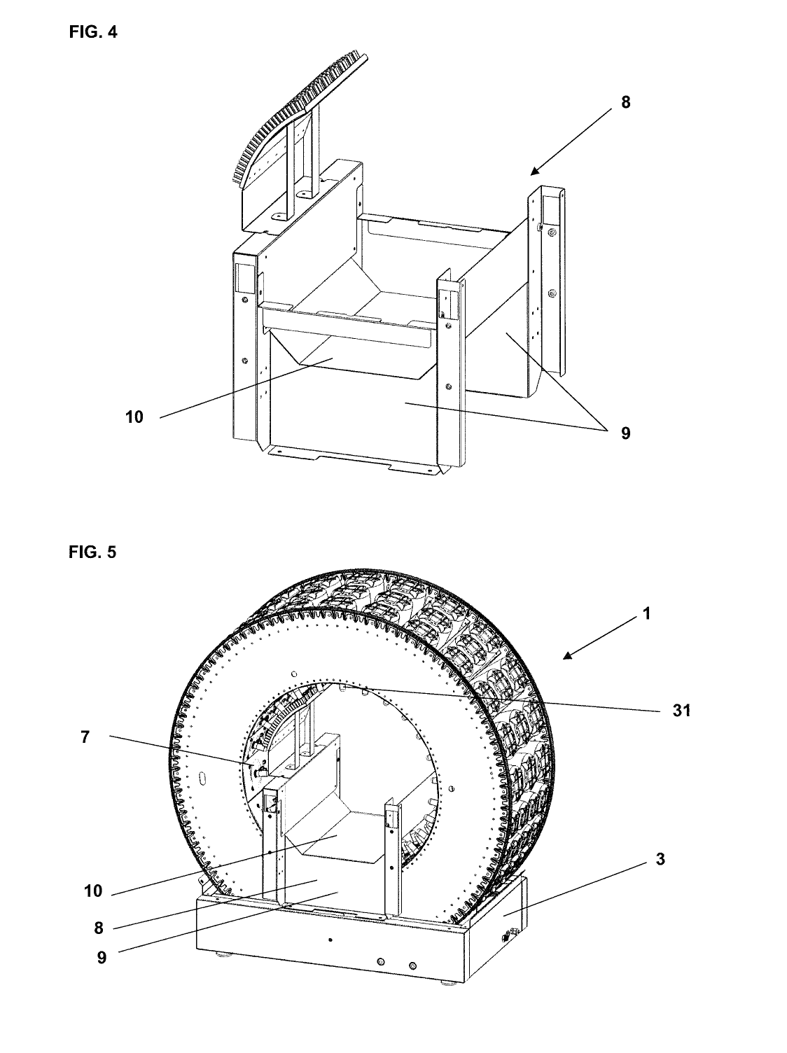

FIG. 4 is a perspective view of the support structure of the bridge type shown on its own;

FIG. 5 is a perspective view of the device with the support structure in the mounted state;

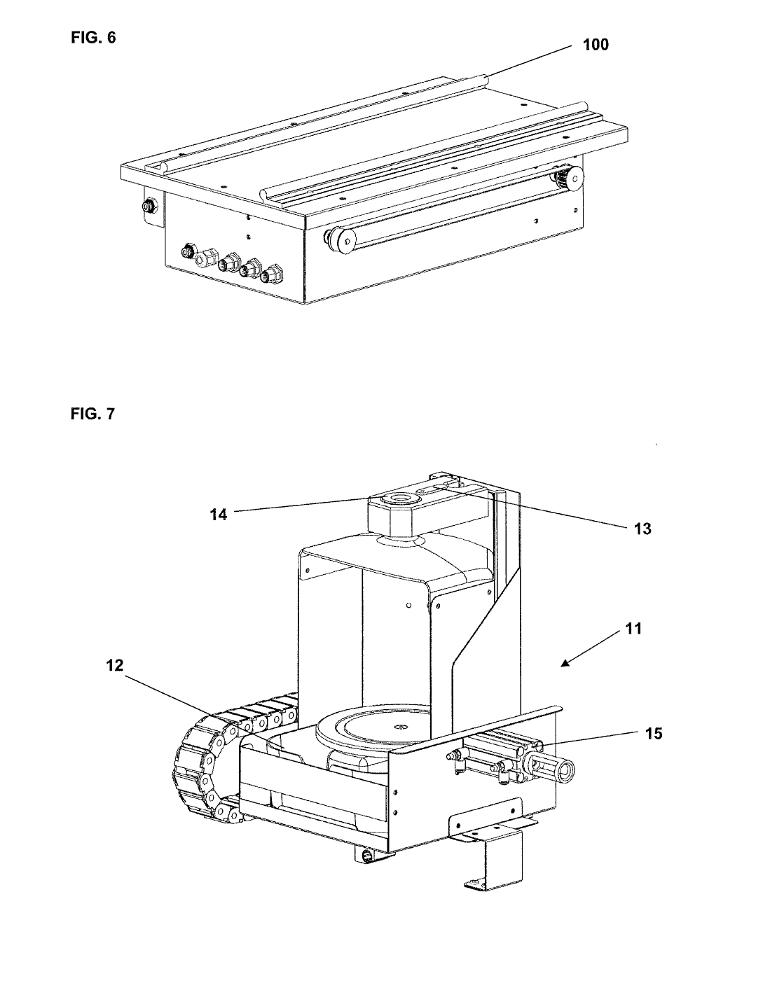

FIG. 6 is a perspective view of the housing designed to be incorporated into the support structure of the bridge type;

FIG. 7 is a perspective view of the carriage on its own in the low position;

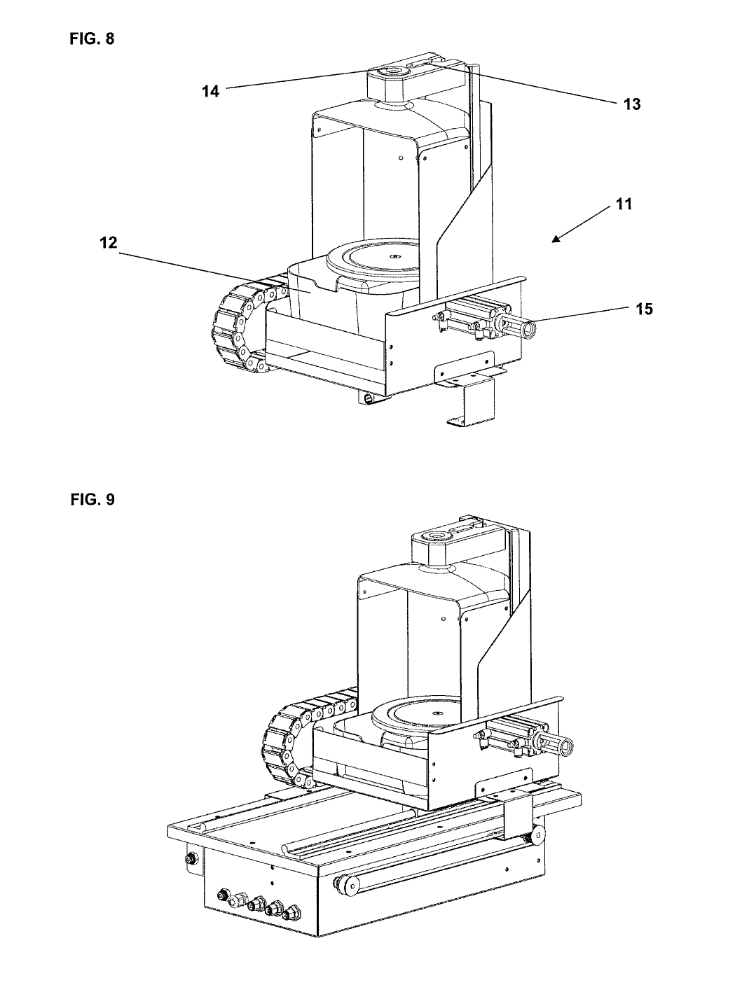

FIG. 8 is a perspective view of the carriage on its own in the high position;

FIG. 9 is a perspective view of the carriage in the state in which it is assembled to the housing shown in FIG. 6;

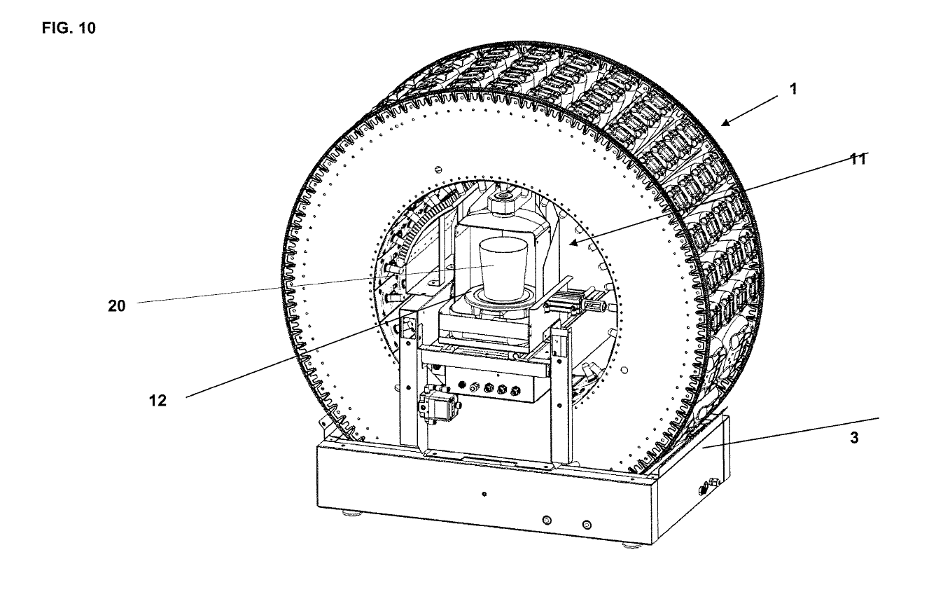

FIG. 10 is a perspective view of the device with the carriage in the state in which it is mounted on the support structure; and

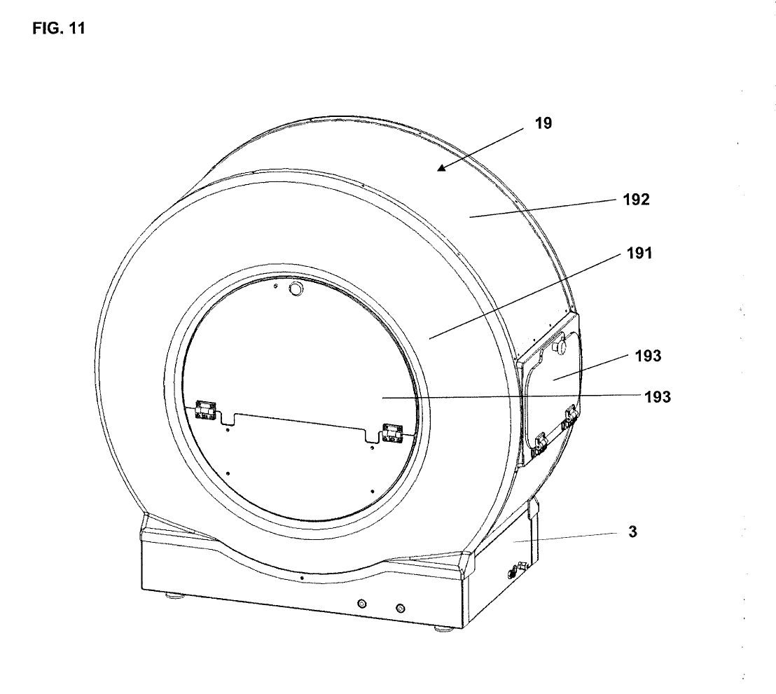

FIG. 11 is a perspective view of the device equipped with its casing.

As mentioned above, the storage, selection, and dispensing device of the invention is more particularly designed to make it possible to mix products, in particular tints of paint, on the basis of a series of tints, each of which is stored in a container, which is generally a flexible container of the pouch type, provided with an expulsion orifice 31 for expelling the fluid contained in said container.

The containers are not described in any further detail below.

Each container may be implemented as in the embodiments described in the present Applicant's Patent EP 2 135 668, namely in the form of a removable flexible pouch that can be inserted into an airtight cell of the products-carrier wheel that is described below, in the form of a rigid or semi-rigid cartridge formed of over-packaging enclosing a flexible pouch, the resulting assembly being insertable into an airtight cell of the products-carrier wheel described below or in the form of a cell enclosing a pouch, the resulting assembly being removably mounted on the products-carrier wheel 1 described below.

The device includes at least one products-carrier wheel 1 that is centrally hollow and has a horizontal axis, and drive means 21, 22, 23 for driving the products-carrier wheel 1 in rotation.

The products-carrier wheel 1 is provided with a plurality of locations 7 for receiving products disposed in at least one circumferential row, each products-receiving location 7 being positionable, by turning the products-carrier wheel 1, into register with a collector receptacle 20.

In a manner characteristic of the invention, the device further includes a base 3 on which the products-carrier wheel 1 is suitable for standing, via the drive means 21, 22, 23 for driving the products-carrier wheel 1 in rotation.

The drive means for driving the products-carrier wheel 1 are thus interposed between the base 3 and the products-carrier wheel 1. In the example shown in FIG. 2, the drive means 21, 22, 23 for driving the wheel in rotation comprise two pairs of rotary circular members 21, 22. Each pair of rotary circular members is formed of two wheels connected together by an axle. The rotary circular members of one of the pairs of rotary circular members are driven rotary circular members. For this purpose, these rotary circular members shown at 21 in the figures mesh with driving means 23, such as a motor-and-gearbox unit. These rotary circular members 21, 22 and driving means 23 are incorporated in the base 3.

In addition to a motor-and-gearbox unit, the rotary-drive driving means include a control unit for controlling said motor-and-gearbox unit and suitable for enabling the wheel to be driven in rotation continuously or intermittently so as to generate, relative to the contents of the containers, a rotating gravity field suitable for preventing particles present in suspension in said products from settling.

This control unit also makes it possible to drive the wheel at a faster speed in order to enable the wheel to be driven in rotation to a dispensing position in which the expulsion orifice is disposed in register with the collector receptacle 20.

In degraded mode, the wheel can be cause to turn to reach a dispensing position by means of two buttons (rightward turning/leftward turning) shown on the base.

In the examples shown, the base 3 is in the form of a box that is open over its top face, said rotary circular members 21, 22 and their rotary-drive driving means 23 being disposed inside the box.

In the configuration in which the products-carrier wheel 1 is bearing on the base 3, the rotary circular members incorporated in the base are members that are tangential to the products-carrier wheel 1, in particular to the outer rim 4 or outer periphery of the products-carrier wheel 1. The rotary circular members 21, 22 extend on either side of a diametrical plane of the products-carrier wheel with their axes of rotation parallel to the axis of rotation of the products-carrier wheel 1.

Thus, the products-carrier wheel 1 is carried and driven in rotation by said rotary circular members 21, 22. In order to facilitate this driving in rotation and in order to avoid slippage phenomena so as to guarantee indexing of the wheel, the circular members 21, 22 are members of the wheel, roller, or cog type, each provided on its outer circumference with at least one set 5 of teeth or notches suitable for coming to mesh with a portion of an outer circumferential set 6 of teeth or notches of the products-carrier wheel 1, in the configuration in which the products-carrier wheel 1 is bearing on the base 3.

By means of this design, the wheel can be mounted and dismounted without using tools and in a short time because, for mounting, it suffices to stand the wheel on the rotary circular members, and for dismounting, it suffices to perform the reverse operation.

As mentioned above, the products-carrier wheel 1 is provided with a plurality of product-receiving locations 7, which locations are disposed in at least one circumferential row. Each product-receiving location 7 is provided with at least one bore through which the expulsion orifice 31 of a products container 30, which orifice is generally incorporated in a valve, is suitable for projecting from the products-carrier wheel 1 radially and inwardly so as to be disposed in register with the collector receptacle 20 when the associated product-receiving location has been selected.

The device further includes support means 8 for supporting said collector receptacle 20, which support means comprise an upside-down U-shaped structure of the bridge type. Each of the flanges 9 of the U-shape extends on the same side as a respective face of the products-carrier wheel 1 and bears against the base 3, while the web 10 of the U-shape, which web is suitable for forming a support frame for the collector receptacle 20, passes through said products-carrier wheel 1.

This U-shaped support structure enables the collector receptacle 20 to be positioned inside the products-carrier wheel 1. The collector receptacle 20 may be formed merely by a cup.

The web 10 of the U-shape of the support structure is provided with a guide path 100, formed, for example, by two rails, parallel to the axis of rotation of the products-carrier wheel 1, when the products-carrier wheel 1 and the support means 8 are in the state in which they are mounted on the base 3.

In the example shown, this guide path 100 is formed by one of the faces of a housing mounted removably on the remainder of the support structure and forming a portion of the web of the U-shape of the support structure. This housing houses the various members for controlling the elements incorporated in the carriage that is described below and that provides the connection to the base 3, which houses, in particular the connection means for connecting to a compressed air source. By way of example, this housing that forms the interface between the carriage and the base houses the pneumatic transit means, the computing communication means, and the electrical power and signal transit means.

A carriage 11 is mounted to slide along the guide path 100. This carriage 11, mounted to move in a direction parallel to the axis of rotation of the products-carrier wheel 1, includes weigh means 12 for weighing the collector receptacle 20, a pressurized air outlet 13 that is closable, and open/close control means 14 for opening and closing the expulsion orifice 31 of the products container when the location 7 for receiving said container 30 is in the state in which it is positioned in register with the collector receptacle 20.

For causing it to slide, the carriage 11 is coupled to an endless transmission member, such as a belt or a chain, incorporated into the support structure. As a result, it is easy to mount/dismount the carriage.

The open/close control means 14 for opening and closing the expulsion orifice 31 of the container that has its associated location for receiving it positioned facing the collector receptacle 20 comprise a cylindrical coil, such as a solenoid, capable of inducing a magnetic field at the valve equipping the container. The details of how this operates are described in the present Applicant's Patent EP 1 975 486.

In the dispensing position, i.e. in the position in which the expulsion orifice 31 of a selected container 30 is disposed in register with the collector receptacle 20, these means 14 are suitable for causing the expulsion orifice 31 to open in controlled manner in order to expel a predetermined metered quantity of product that is controlled by the weigh means into the collector receptacle.

The closable pressurized air outlet 13 of the carriage 11 constitutes the outlet of a pneumatic circuit going through the base 3 and through the housing of the support means 8. This circuit is fed with air from a compressed air source that is generally external to the device and that is connected to the base 3. In the dispensing position, i.e. in the position in which the expulsion orifice 31 of a selected container 30 is disposed in register with the collector receptacle 20, this pressurized air outlet 13 of the carriage 11 is designed to communicate with a through air feed orifice 18 disposed on the products-carrier wheel 1 and communicating with the closed and therefore airtight internal volume of a cell of the container, as described above.

This pressure source makes it possible to pressurize the flexible pouch of the container and induces deformation of the pouch and thereby expulsion of at least a fraction of the contents of the container. The way this operates is described in Patent EP 2 135 668.

For the reasons mentioned above, each product-receiving location 7 of the products-carrier wheel 1 is provided with at least two series of through orifices 17, 18, each of which is disposed in at least one circumferential row. Each of the orifices 17 of the first series of through orifices corresponds to a bore through which the expulsion orifice 31 of a product container 30, which orifice is incorporated in a valve, is suitable for projecting from the products-carrier wheel 1. Each of the orifices 18 of the second series of through orifices corresponds to an air feed inlet.

As a function of the angular position of said products-carrier wheel, the orifices of the first series of orifices are selectively positionable to be facing the open/close control means for opening and closing the expulsion orifice of the product container of the carriage and the orifices of the second series of orifices are selectively positionable to be facing the pressurized air outlet of the carriage.

The carriage going from the low position to the high position in this way is shown in FIGS. 7 and 8. This raising makes it possible to insert the valve into its open/close control means 14 and to put the air feed under pressure.

In addition, each product-receiving location 7 is associated with locking means 15 suitable for locking the product container 30 at said product-receiving location 7, these locking means 16 being unlockable via unlocking means 15 carried by said carriage 11.

Said locking means 16 may be formed by a split ring positioned at the base of the valve in its zone of connection to the container, said ring expanding after the valve is inserted into a through orifice 17 of the wheel in such a manner as to prevent untimely dismounting of said container 30 from the products-carrier wheel 1.

The unlocking means 15 carried by the carriage 11 may be formed by an actuator, e.g. a pneumatic actuator, on which a specific end-piece is mounted that is suitable for tightening the ring around the valve so as to allow the container to be dismounted from the products-carrier wheel 1.

Finally, the storage device further includes a casing 19 formed, in the example shown, by two side walls 191, each of which is suitable for covering one face of the products-carrier wheel 1, and by a strip 192 suitable for covering the outer peripheral portion of the wheel, at least one of the side walls 191 and the strip 192 each being provided with an access door 193.

By means of this simplified architecture of the device, said device is quick to mount and to dismount.

1. A storage device for storing, selecting, and dispensing a plurality of products, in particular a series of base tints for automotive paint, each of which is packaged in a container (30) provided with an expulsion orifice (31), said device including at least one products-carrier wheel (1) that is centrally hollow has a horizontal axis, and drive means (21, 22, 23) for driving the products-carrier wheel (1) in rotation, said products-carrier wheel (1) being provided with a plurality of product-receiving locations (7) disposed in at least one circumferential row, each product-receiving location (7) being selectively positionable by turning the products-carrier wheel (1) into register with a collector receptacle (20), said storage device being characterized in that the device further includes a base (3) on which the products-carrier wheel (1) is suitable, via the drive means (21, 22, 23) for driving the products-carrier wheel (1) in rotation, for standing merely by bearing against said base, said drive means (21, 22, 23) for driving the products-carrier wheel (1) in rotation comprising at least two rotary circular members (21, 22), at least one (21) of the rotary circular members (21, 22) being a driven member, these rotary circular members (21, 22), incorporated into the base (3) being members that, when the products-carrier wheel (1) is in the configuration in which it is bearing on the base (3), are tangential to the products-carrier wheel (1) and in particular to the outer rim of the products-carrier wheel (1), and extend on either side of a diametrical plane of the products-carrier wheel (1), with their axes of rotation parallel to the axis of rotation of the products-carrier wheel (1).

2. A storage device according to claim 1, characterized in that the circular members (21, 22) are members of the wheel, roller, or cog type, each provided on its outer circumference with at least one set (5) of teeth or notches suitable for coming to mesh with a portion of an outer circumferential set (6) of teeth or notches of the products-carrier wheel (1), in the configuration in which the products-carrier wheel (1) is bearing on the base (3).

3. A storage device according to claim 1, characterized in that the base (3) is in the form of a box that is open over its top face, said rotary circular members (21, 22) and their rotary-drive driving means (23) being disposed inside the box.

4. A storage device according to claim 1, characterized in that the device further includes support means (8) for supporting said collector receptacle (20), which means comprise at least one upside-down U-shaped structure of the bridge type, each of the flanges (9) of the U-shape extending on the same side as a respective face of the products-carrier wheel (1) and bearing on the base (3) while the web (10) of the U-shape, which web is suitable for forming a support frame for the collector receptacle (20), passes through said products-carrier wheel (1).

5. A storage device according to claim 4, characterized in that the web (10) of the U-shape is provided with a guide path (100) along which a carriage (11) is mounted to slide in a direction parallel to the axis of rotation of the products-carrier wheel (1), said carriage (11) including weigh means (12) for weighing the collector receptacle (20), a closable pressurized air outlet (13) and open/close control means (14) for opening and closing the expulsion orifice (31) of the product container (30) in the state in which the product-receiving location (7) of said container (30) is positioned in register with the collector receptacle (20), said weigh means (12), the pressurized air outlet (13) and the control means (14) being mounted to move upwards and downwards on said carriage (11).

6. A storage device according to claim 5, characterized in that at least a portion of the web (10) of the U-shape incorporates a removable housing having one of its faces provided with said guide path (100) along which the carriage (11) is mounted to slide, said housing being an interface housing forming an interface between the carriage (11) and the base (3).

7. A storage device according to claim 1, characterized in that each product-receiving location (7) is associated with locking means (16) suitable for locking the product container (30) at said product-receiving location (7), said locking means (16) being unlockable via unlocking means (15) carried by said carriage (11).

8. A storage device according to claim 1, characterized in that each product-receiving location (7) of the products-carrier wheel (1) is provided with at least two series of through orifices (17, 18), each of which is disposed in at least one circumferential row, each of the orifices (17) of the first series of through orifices corresponding to a bore through which the expulsion orifice (31) of a product container (30), which orifice is incorporated into a valve, is suitable for projecting from the products-carrier wheel (1), each of the orifices (18) of the second series of through orifices corresponding to an air feed inlet.

9. A storage device according to claim 1, characterized in that it further includes a casing (19) formed at least by a side wall (191), provided with an access door (193).

10. A storage device according to claim 2, characterized in that the base (3) is in the form of a box that is open over its top face, said rotary circular members (21, 22) and their rotary-drive driving means (23) being disposed inside the box.
